(19) United States
(12) Patent Application Publication
(10) Pub. No.: US 2010/0258209 A1
(43) Pub. Date: Oct. 14, 2010

(54) System and Method for draining a Boiler using a Three Way Valve

(76) Inventor: Kevin S. Eggerth, Blaine, MN (US)

Correspondence Address: WILSON DANIEL SWAYZE, JR., 3804 CLEARWATER CT., PLANO, TX, 75025, US

(21) Appl. No.: 12/421,258

(22) Filed: Apr. 9, 2009

(51) Int. Cl. F16K 11/00

(52) U.S. Cl. 137/625

(57) ABSTRACT

A draining valve for draining the boiler may include a first port connected to a pressurized tank, a second port connected to an output tube, a third port connected to the boiler, and a control valve to selectively connect the pressurized tank to the boiler and to connect the boiler to the output tube. The first port may be adapted to be closed while the third port is open, and the first port may be adapted to be opened while the third port is closed. The second port may be opened while the first port is closed, and the second port may be open while the first port is open. The central valve may include a central passageway, and the central valve may include a traverse passageway. The first port may selectively connect to the traverse passageway, and the third port may selectively connect to the traverse passageway. The second port may connect to the central passageway.

### FIELD OF THE INVENTION

The present invention relates to boilers and more particularly to hot water heaters and a system and method for draining the water heaters.

### BACKGROUND

A boiler which may be known as a water heater or hydronics expansion tank for use in general homes and buildings is used for heating water and supplying hot water.

With these boilers, natural gas may be burned or electric resistance wires may be heated to act as a heat source for heating a fluid such as water.

These boilers may need to be drained routinely in order to clean sediment which may form in the bottom of these boilers. However, the sediment may become sufficiently large in order to adversely effect the drainage valve which may be located at the bottom of the boiler. Under these circumstances the water may drain very slowly or be completely blocked from draining.

An additional problem is draining boilers when they are located below the surface. Pumps may be required in order to drain the boiler and to transfer the water to the surface.

### SUMMARY

A draining valve for draining the boiler may include a first port connected to a pressurized tank, a second port connected to an output tube, a third port connected to the boiler, and a control valve to selectively connect the pressurized tank to the boiler and to connect the boiler to the output tube.

The first port may be adapted to be closed while the third port is open, and the first port may be adapted to be opened while the third port is closed.

The second port may be opened while the first port is closed, and the second port may be open while the first port is open.

The central valve may include a central passageway, and the central valve may include a traverse passageway.

The first port may selectively connect to the traverse passageway, and the third port may selectively connect to the traverse passageway.

The second port may connect to the central passageway.

A method for draining the boiler may include the steps of opening a first port connected to a pressurized tank, closing a second port connected to an output tube, opening a third port connected to a boiler, pressurizing the boiler, closing the first port connected to the pressurized tank, and opening the second port connected to the output tube in order to drain the boiler.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the three-way valve of the present invention;

FIG. 2 illustrates a front view of the three-way valve of the present invention;

FIG. 3 illustrates a side view of the three-way valve being used with the weather and pressurized tank of the present invention;

FIG. 4 illustrates a cross-sectional view of the three-way valve of the present invention;

FIG. 5 illustrates another cross-sectional view of the three way valve of the present invention.

### DETAILED DESCRIPTION

The present invention may include a draining valve 100 or manifold which may be a three-way valve which may be used to drain a boiler (or other container of liquid) 113 in order to alternatively drain and then pressurize the boiler 113 in order to agitate or stir the sediment to promote a complete draining of the boiler 113. Furthermore, the boiler 113 when pressurized, may transmit the water a predetermined height allowing the boiler 113 to be drained even if the boiler 113 is located below ground level 114. By boiler, the present invention includes water heaters and hydronics expansion tanks.

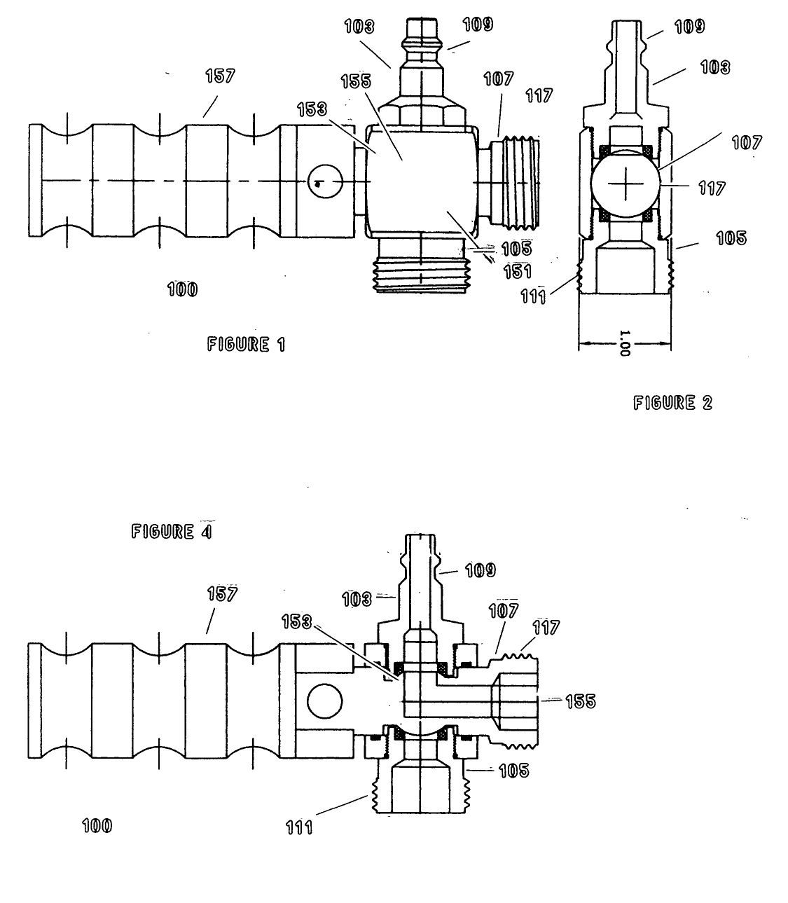

FIG. 1 illustrates the draining device 100 which may include a first port 103 which may include a pressurized air input port 109 which may be adapted to receive and connect to a pressurize hose 133 which may be connected to a tank 135 or container which may be filled with pressurized fluid such as air. The draining valve 100 may include a second port 105 which may be opposingly positioned to the first port 103. The second port 105 may include a threaded input port 111 to allow a threaded connection to an output tube 131.

The draining valve 100 may include a third port 107 which may include a threaded output port 117 to be threadingly connected to the boiler 113 by a connecting tube 115 which may be connected to the drain of the boiler 113.

The draining valve 100 may include a control valve 151 which may rotate in order to selectively connect the first port 103 to the third port 107 or to selectively connect the second port 105 to the third port 107. The control valve 151 may include a central passageway 155 to cooperate with a traverse passageway 153. The traverse passageway 153 is rotated to cooperate with the first port 103 at the first position and to cooperate with the second port 105 at a second position. The control valve 151 may be connected to a handle 157 for a user to rotate.

FIG. 2 illustrates a front view of the draining valve 100 of the present invention and illustrates the threaded output port 117, the second port 105, the first port 103, the compressed air input port 109 and the third port 107.

FIG. 3 illustrates a system view of the draining device 100 which may include a first port 103 which may include a pressurized air input port 109 which may be adapted to receive and connect to a pressurize hose 133 which may be connected to a tank 135 or container which may be filled with pressurized fluid such as air. The draining valve 100 may include a second port 105 which may be opposingly positioned to the first port 103. The second port 105 may include a threaded input port 111 to allow a threaded connection to an output tube 131.

The draining valve 100 may include a third port 107 which may include a threaded output port 117 to be threadingly connected to the boiler 113 by a connecting tube 115 which may be connected to the drain of the boiler 113.

The draining valve 100 may include a control valve 151 which may rotate in order to selectively connect the first port 103 to the third port 107 or to selectively connect the second port 105 to the third port 107. The control valve 151 may include a central passageway 155 to cooperate with a traverse passageway 15 3. The traverse passageway 153 is rotated to cooperate with the first port 103 at the first position and to cooperate with the second port 105 at a second position. The control valve 151 may be connected to a handle 157 for a user to rotate.

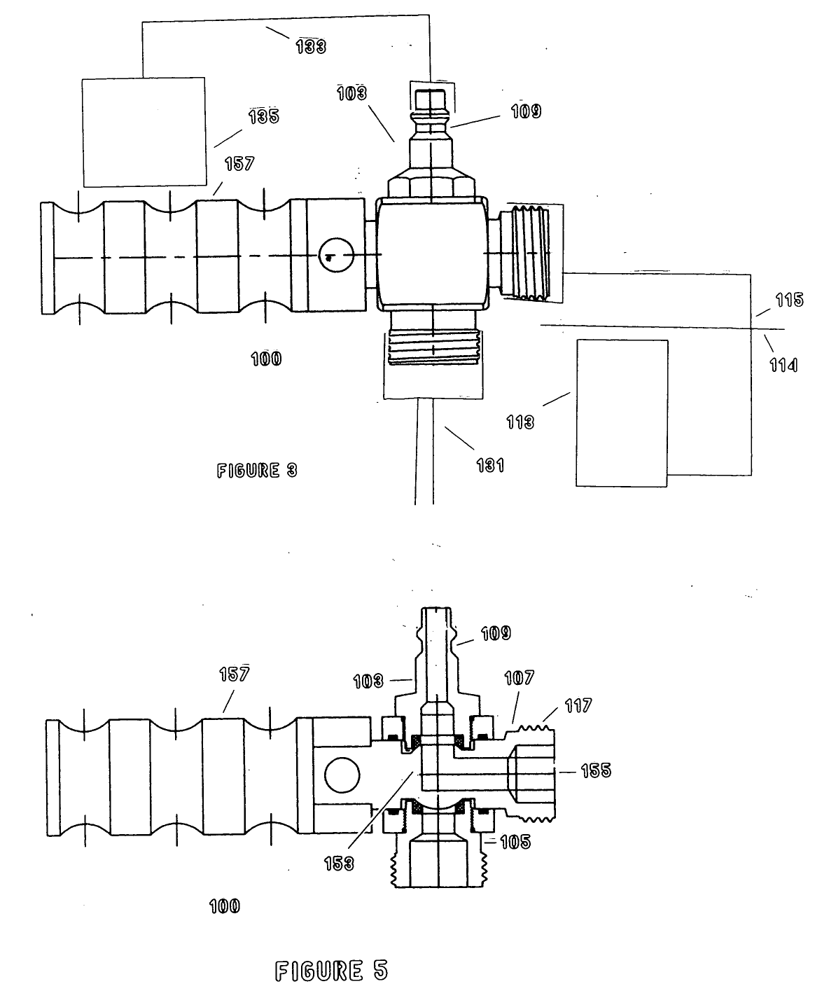

FIG. 4 illustrates a cross-sectional view of the draining device 100 which may include a first port 103 which may include a pressurized air input port 109 which may be adapted to receive and connect to a pressurize hose 133 which may be connected to a tank 135 or container which may be filled with pressurized fluid such as air. The draining valve 100 may include a second port 105 which may be opposingly positioned to the first port 103. The second port 105 may include a threaded input port 111 to allow a threaded connection to an output tube 131.

The draining valve 100 may include a third port 107 which may include a threaded output port 117 to be threadingly connected to the boiler 113 by a connecting tube 115 which may be connected to the drain of the boiler 113.

The draining valve 100 may include a control valve 151 which may rotate in order to selectively connect the first port 103 to the third port 107 or to selectively connect the second port 105 to the third port 107. The control valve 151 may include a central passageway 155 to cooperate with a traverse passageway 15 3. The traverse passageway 153 is rotated to cooperate with the first port 103 at the first position and to cooperate with the second port 105 at a second position. The control valve 151 may be connected to a handle 157 for a user to rotate.

In FIG. 4, the traverse passageway 153 cooperates with the compressed air input port 109 at the first position to receive compressed fluid which may be air and transmit the compressed flow and to the central passageway 155 which cooperates with the output port 117 to pressurize the boiler 113 and to dislodge any objects which may be blocking the objects which may be blocking the draining valve of the boiler 113. Consequently, the pressurizing of the boiler 113 tends to stir the boiler 113. FIG. 5 illustrates a cross-sectional view of the draining device 100 which may include a first port 103 which may include a pressurized air input port 109 which may be adapted to receive and connect to a pressurize hose 133 which may be connected to a tank 135 or container which may be filled with pressurized fluid such as air. The draining valve 100 may include a second port 105 which may be opposingly positioned to the first port 103. The second port 105 may include a threaded input port 111 to allow a threaded connection to an output tube 131.

The draining valve 100 may include a third port 107 which may include a threaded output port 117 to be threadingly connected to the boiler 113 by a connecting tube 115 which may be connected to the drain of the boiler 113.

The draining valve 100 may include a control valve 151 which may rotate in order to selectively connect the first port 103 to the third port 107 or to selectively connect the second port 105 to the third port 107. The control valve 151 may include a central passageway 155 to cooperate with a traverse passageway 153. The traverse passageway 153 is rotated to cooperate with the first port 103 at the first position and to cooperate with the second port 105 at a second position. The control valve 151 may be connected to a handle 157 for a user to rotate.

In FIG. 5, the central passageway 115 cooperates with the threaded input port 111 to receive fluid stored within the boiler 113 which may be water and transmit the fluid to the traverse passageway 113 in the second position and which cooperates with the input port 111 to transmit the fluid to the output tube 113. The pressurized boiler 113 allows the fluid to flow a height so that the boiler 113 may be positioned below ground level and the fluid can be transmitted to ground level, avoiding the need to manually carry the water.

The control valve 151 may be repeatedly moved between the first position and the second position in order to repeatedly pressurize the boiler 113 and completely drain the boiler 113.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A draining valve for draining the boiler, comprising:
a first port connected to a pressurized tank;
a second port connected to an output tube;
a third port connected to the boiler;
a control valve to selectively connect the pressurized tank to the boiler and to connect the boiler to the output tube.

2) A draining valve for draining the boiler as in claim 1, wherein the first port is adapted to be closed while the third port is open.

3) A draining valve for draining the boiler as in claim 1, wherein the first port is adapted to be opened while the third port is closed.

4) A draining valve for draining the boiler as in claim 1, wherein the second port is opened while the first port is closed.

5) A draining valve for draining the boiler as in claim 1, wherein the second port is open while the first port is open.

6) A draining valve for draining the boiler as in claim 1, wherein the central valve includes a central passageway.

7) A draining valve for draining the boiler as in claim 1, wherein the central valve includes a traverse passageway.

8) A draining valve for draining the boiler as in claim 7, wherein the first port selectively connects to the traverse passageway.

9) A draining valve for draining the boiler as in claim 7, wherein the third port selectively connects to the traverse passageway.

10) A draining valve for draining the boiler as in claim 6, wherein the second port connects to the central passageway.

11) A method for draining the boiler, comprising the steps of;
opening a first port connected to a pressurized tank;
closing a second port connected to an output tube;
opening a third port connected to a boiler;
pressurizing the boiler;
closing the first port connected to the pressurized tank
opening the second port connected to the output tube in order to drain the boiler.

12) A method for draining the boiler as in claim 11, wherein the above steps are repeated.
